(19) United States
(12) Patent Application Publication
(10) Pub. No.: US 2021/0190533 A1
(43) Pub. Date: Jun. 24, 2021

(54) INFORMATION PROCESSING DEVICE, INFORMATION PROCESSING SYSTEM, PROGRAM, AND INFORMATION PROCESSING METHOD

(71) Applicant: TOYOTA JIDOSHA KABUSHIKI KAISHA, Toyota-shi (JP)

(72) Inventors: Takuji YAMADA, Tokyo (JP); Jun TSUKAMOTO, Seto-shi (JP); Kaori SAKAI, Miyoshi-shi (JP)

(73) Assignee: TOYOTA JIDOSHA KABUSHIKI KAISHA, Toyota-shi (JP)

(21) Appl. No.: 17/080,175

(22) Filed: Oct. 26, 2020

(30) Foreign Application Priority Data
Dec. 18, 2019 (JP) 2019-228593

(51) Int. Cl. G01C 21/36; G08G 1/127; G01C 21/34

(52) U.S. Cl. CPC G01C 21/3697; H04L 67/42; G01C 21/3453; G08G 1/127

(57) ABSTRACT

An information processing device includes a controller configured to acquire an expected arrival time at a destination based on route guidance to a user, acquire an action start time of the user at the destination, calculate a spare time between the expected arrival time and the action start time, extract a stopover candidate to stop over from among a plurality of stopover candidates based on the spare time, and transmit information regarding the extracted stopover candidate to a device used by the user.

### CROSS-REFERENCE TO RELATED APPLICATION

This application claims priority to Japanese Patent Application No. 2019-228593 filed on Dec. 18, 2019, incorporated herein by reference in its entirety.

### BACKGROUND

### 1. Technical Field

The present disclosure relates to an information processing device, an information processing system, a program, and an information processing method.

### 2. Description of Related Art

Hitherto, a navigation device that calculates an expected arrival time at a destination is known. For example, Japanese Unexamined Patent Application Publication No. 2013-68422 (JP 2013-68422 A) discloses a technique that estimates a destination based on information regarding a current place, or the like, and calculates an expected arrival time at the estimated destination.

### SUMMARY

According to the technique described in JP 2013-68422 A, the expected arrival time is merely notified to a user as it is, and beneficial information based on the expected arrival time is not provided.

The present disclosure provides beneficial information based on an expected arrival time.

A first aspect of the present disclosure relates to an information processing device. The information processing device includes a controller. The controller is configured to acquire an expected arrival time at a destination based on route guidance to a user, acquire an action start time of the user at the destination, calculate a spare time between the expected arrival time and the action start time, extract a stopover candidate to stop over from among a plurality of stopover candidates based on the spare time, and transmit information regarding the extracted stopover candidate to a device used by the user.

A second aspect of the present disclosure relates to a program. The program causes a computer to execute: acquiring an expected arrival time at a destination based on route guidance to a user; acquiring an action start time of the user at the destination; calculating a spare time between the expected arrival time and the action start time; extracting a stopover candidate to stop over from among a plurality of stopover candidates based on the spare time; and transmitting information regarding the extracted stopover candidate to a device used by the user.

A third aspect of the present disclosure relates to an information processing method. The information processing method includes: acquiring an expected arrival time at a destination based on route guidance to a user; acquiring an action start time of the user at the destination; calculating a spare time between the expected arrival time and the action start time; extracting a stopover candidate to stop over from among a plurality of stopover candidates based on the spare time; and transmitting information regarding the extracted stopover candidate to a device used by the user.

According to the present disclosure, it is possible to provide beneficial information based on an expected arrival time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of an information processing system according to an embodiment of the present disclosure;

FIG. 2 is a block diagram showing the configuration of an information processing device according to the embodiment of the present disclosure;

FIG. 3 is a block diagram showing the configuration of a navigation device according to the embodiment of the present disclosure;

FIG. 4 is a block diagram showing the configuration of a server device according to the embodiment of the present disclosure;

FIG. 5 is a diagram showing an example where stopover candidates are displayed on the navigation device;

FIG. 6 is a flowchart showing an operation of the information processing system according to the embodiment of the present disclosure;

FIG. 7 is a flowchart showing an operation of the information processing system according to the embodiment of the present disclosure; and

FIG. 8 is a flowchart showing an operation of the information processing system according to the embodiment of the present disclosure.

### DETAILED DESCRIPTION OF EMBODIMENTS

Hereinafter, an embodiment of the present disclosure will be described referring to the drawings.

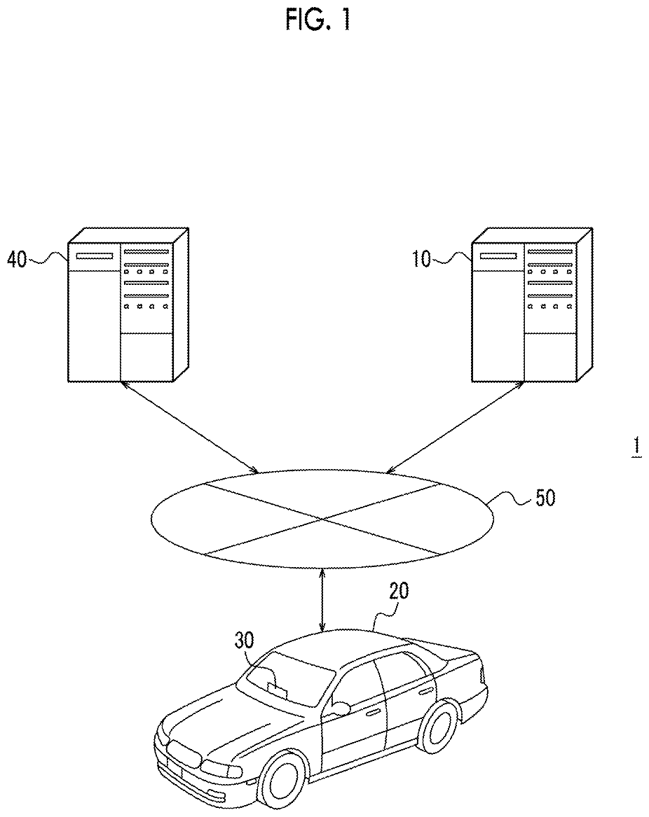

FIG. 1 is a diagram showing the configuration of an information processing system 1 according to the embodiment of the present disclosure. Referring to FIG. 1, the configuration and the outline of the information processing system 1 according to the embodiment of the present disclosure will be described.

The information processing system 1 includes an information processing device 10, a navigation device 30 mounted in a vehicle 20, and a server device 40. The information processing device 10, the navigation device 30, and the server device 40 are connected in a communicable manner through a network 50. The network 50 may be a network including a mobile communication network, the Internet, and the like.

In FIG. 1, although one information processing device 10, one vehicle 20, one navigation device 30, and one server device 40 are shown, the number of information processing devices 10, the number of vehicles 20, the number of navigation devices 30, and the number of server devices 40 may be two or more.

The information processing device 10 is, for example, a dedicated computer configured to function as a server. The information processing device 10 may be a general-purpose personal computer (PC).

The information processing device 10 can perform communication with the navigation device 30 and the server device 40 through the network 50. The information processing device 10 acquires information regarding the destination, the expected arrival time, and the like from the navigation device 30. The information processing device 10 acquires schedule information of the user of the navigation device 30 from the server device 40. The information processing device 10 extracts an action start time of the user at the destination from the schedule information and calculates a spare time between the expected arrival time and the action start time. The information processing device 10 transmits information regarding a stopover candidate to stop over for the spare time to the navigation device 30.

The vehicle 20 is, for example, any kind of vehicle, such as a gasoline vehicle, a diesel vehicle, a hybrid vehicle (HV), a plug-in hybrid vehicle (PHV), an electric vehicle (EV), or a fuel cell vehicle (FCV). The vehicle 20 is driven by a driver in the embodiment, and may be a vehicle that performs autonomous driving at any level. The level of autonomous driving is, for example, one of level 1 to level 5 in level classification of Society of Automotive Engineers (SAE). The vehicle 20 may be a dedicated vehicle for Mobility as a Service (MaaS).

The navigation device 30 is mounted in the vehicle 20. The navigation device 30 may be in-vehicle dedicated car navigation equipment or may be electronic equipment, such as a smartphone or a tablet, that is executable a navigation application. The navigation device 30 may be any device used by the user of the vehicle 20 as long as a navigation function is executable.

In a case where a destination is set by the user, the navigation device 30 searches for a route to the destination and calculates an expected arrival time at the destination.

The server device 40 is, for example, a dedicated computer configured to function as a server. The server device 40 may be a general-purpose PC.

The server device 40 functions as a server in a cloud computing system. The server device 40 stores information regarding a calendar application that is provided by the cloud computing system in which the server device 40 functions as a server. The server device 40 stores the schedule information of the user who uses the calendar application.

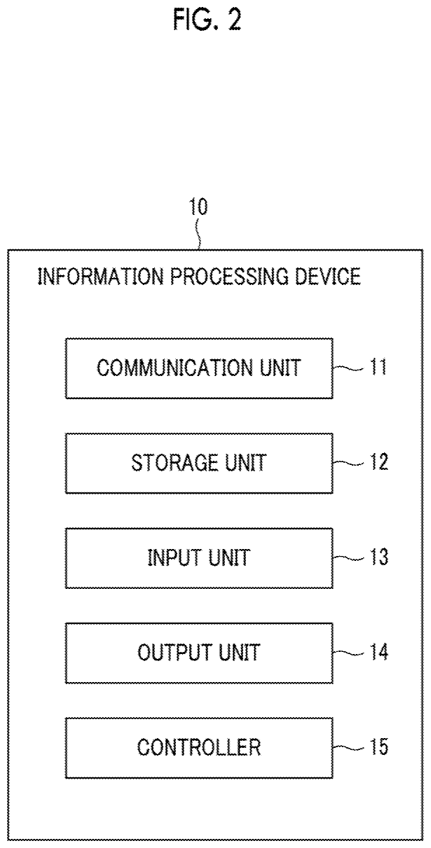

Referring to FIG. 2, the configuration of the information processing device 10 according to the embodiment of the present disclosure will be described.

The information processing device 10 includes a communication unit 11, a storage unit 12, an input unit 13, an output unit 14, and a controller 15.

The communication unit 11 includes a communication module that is connected to the network 50. For example, the communication unit 11 may include a communication module corresponding to a local area network (LAN). In the embodiment, the information processing device 10 is connected to the network 50 through the communication unit 11. The communication unit 11 transmits and receives various kinds of information through the network 50. The communication unit 11 can perform communication with the navigation device 30 and the server device 40 through the network 50.

The storage unit 12 is, for example, a semiconductor memory, a magnetic memory, an optical memory, or the like, but is not limited thereto. The storage unit 12 may function as, for example, a main storage device, an auxiliary storage device, or a cache memory. The storage unit 12 stores any information for use in the operation of the information processing device 10. For example, the storage unit 12 may store a system program, application programs, various kinds of information received by the communication unit 11, and the like. Information stored in the storage unit 12 may be updated with, for example, information received from the network 50 through the communication unit 11. A part of the storage unit 12 may be provided outside the information processing device 10. In this case, a part of the storage unit 12 provided in the outside may be connected to the information processing device 10 through any interface.

The input unit 13 includes one or more input interfaces that detect a user input to acquire input information based on a user's operation. For example, the input unit 13 is a physical key, a static capacitance key, a touch screen provided integrally with a display of the output unit 14, a microphone that receives a voice input, or the like, but is not limited thereto.

The output unit 14 includes one or more output interfaces that output information to give notification to the user. For example, the output unit 14 is a display that outputs information by video, a speaker that outputs information by voice, or the like, but is not limited thereto.

The controller 15 includes at least one processor, at least one dedicated circuit, or a combination thereof. The processor is a general-purpose processor, such as a central processing unit (CPU) or a graphics processing unit (GPU), or a dedicated processor specialized for specific processing. The dedicated circuit is, for example, a field-programmable gate array (FPGA) or an application specific integrated circuit (ASIC). The controller 15 executes processing relating to the operation of the information processing device 10 while controlling the respective units of the information processing device 10.

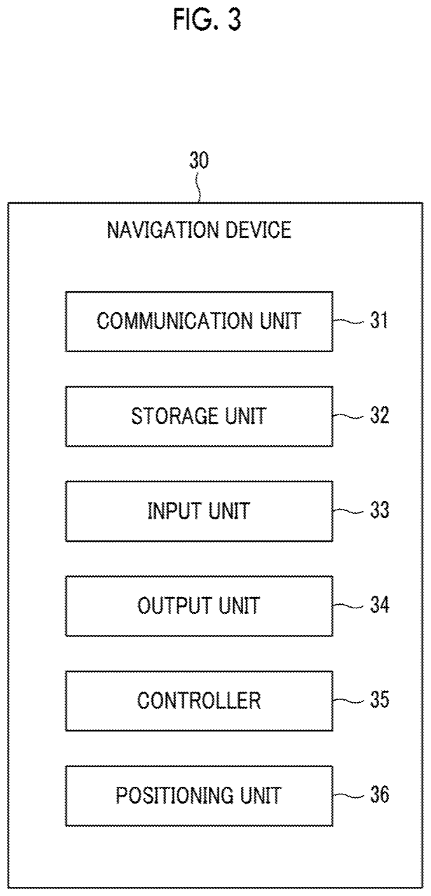

Referring to FIG. 3, the configuration of the navigation device 30 according to the embodiment of the present disclosure will be described.

The navigation device 30 includes a communication unit 31, a storage unit 32, an input unit 33, an output unit 34, a controller 35, and a positioning unit 36.

The communication unit 31 includes a communication module that is connected to the network 50. For example, the communication unit 31 may include a communication module corresponding to a mobile communication standard, such as Long Term Evolution (LTE), 4th Generation (4G), or 5th Generation (5G). In one embodiment, the navigation device 30 is connected to the network 50 through the communication unit 31. The communication unit 31 transmits and receives various kinds of information through the network 50. The communication unit 31 can perform communication with the information processing device 10 and the server device 40 through the network 50.

The storage unit 32 is, for example, a semiconductor memory, a magnetic memory, an optical memory, or the like, but is not limited thereto. The storage unit 32 may function as, for example, a main storage device, an auxiliary storage device, or a cache memory. The storage unit 32 stores any kind of information for use in the operation of the navigation device 30. For example, the storage unit 32 may store a system program, application programs, various kinds of information received by the communication unit 31, and the like. Information stored in the storage unit 32 may be updated with, for example, information received from the network 50 through the communication unit 31.

The input unit 33 includes one or more input interfaces that detect a user input to acquire input information based on a user's operation. For example, the input unit 33 is a physical key, a static capacitance key, a touch screen provided integrally with a display of the output unit 34, a microphone that receives a voice input, or the like, but is not limited thereto.

The output unit 34 includes one or more output interfaces that output information to give notification to the user. For example, the output unit 34 is a display that outputs information by video, a speaker that outputs information by voice, or the like, but is not limited thereto. In the embodiment, a case where the output unit 34 is a display will be described as an example.

The controller 35 includes at least one processor, at least one dedicated circuit, or a combination thereof. The processor is a general-purpose processor, such as a CPU or a GPU, or a dedicated processor specialized for specific processing. The dedicated circuit is, for example, an FPGA or an ASIC. The controller 35 executes processing relating to the operation of the navigation device 30 while controlling the respective units of the navigation device 30.

The positioning unit 36 includes one or more receivers corresponding to any satellite positioning system. For example, the positioning unit 36 may include a global positioning system (GPS) receiver. The positioning unit 36 acquires a measured value of a position of the navigation device 30 as positional information. The positional information includes, for example, an address, a latitude, a longitude, an altitude, or the like.

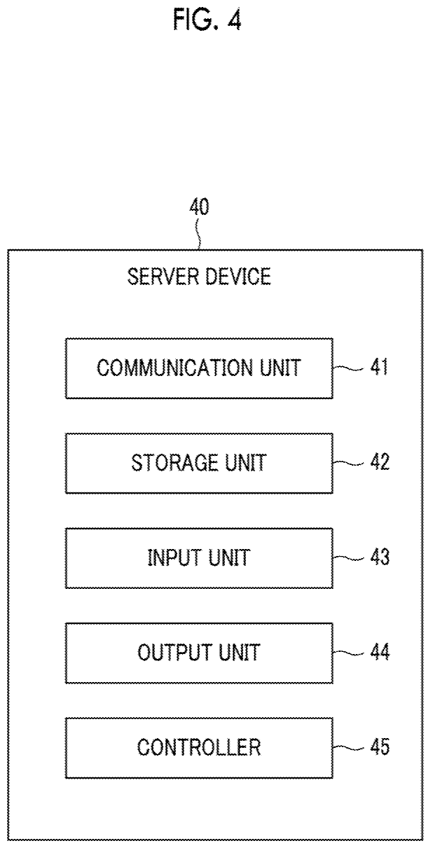

Referring to FIG. 4, the configuration of the server device 40 according to the embodiment of the present disclosure will be described.

The server device 40 includes a communication unit 41, a storage unit 42, an input unit 43, an output unit 44, and a controller 45.

The communication unit 41 includes a communication module that is connected to the network 50. For example, the communication unit 41 may include a communication module corresponding to a LAN. In one embodiment, the server device 40 is connected to the network 50 through the communication unit 41. The communication unit 41 transmits and receives various kinds of information through the network 50. The communication unit 41 can perform communication with the information processing device 10 and the navigation device 30 through the network 50.

The storage unit 42 is, for example, a semiconductor memory, a magnetic memory, an optical memory, or the like, but is not limited thereto. The storage unit 42 may function as, for example, a main storage device, an auxiliary storage device, or a cache memory. The storage unit 42 stores any kind of information for use in the operation of the server device 40. For example, the storage unit 42 may store a system program, application programs, various kinds of information received by the communication unit 41, and the like. Information stored in the storage unit 42 may be updated with, for example, information received from the network 50 through the communication unit 41. A part of the storage unit 42 may be provided outside the server device 40. In this case, a part of the storage unit 42 provided outside may be connected to the server device 40 through any interface.

The input unit 43 includes one or more input interfaces that detect a user input to acquire input information based on a user's operation. For example, the input unit 43 is a physical key, a static capacitance key, a touch screen provided integrally with a display of the output unit 44, a microphone that receives a voice input, or the like, but is not limited thereto.

The output unit 44 includes one or more output interfaces that output information to give notification to the user. For example, the output unit 44 is a display that outputs information by video, a speaker that outputs information by voice, or the like, but is not limited thereto.

The controller 45 includes at least one processor, at least one dedicated circuit, or a combination thereof. The processor is a general-purpose processor, such as a CPU or a GPU, or a dedicated processor specialized for specific processing. The dedicated circuit is, for example, an FPGA or an ASIC. The controller 45 executes processing relating to the operation of the server device 40 while controlling the respective units of the server device 40.

Operation of Information Processing System

The operation of the information processing system 1 shown in FIG. 1 will be described.

The input unit 33 of the navigation device 30 receives an input of a destination from a user of the navigation device 30. The user of the navigation device 30 is, for example, a driver who drives the vehicle 20. The user of the navigation device 30 may be an occupant of the vehicle 20 other than the driver.

In a case where the input unit 33 receives the input of the destination, the controller 35 of the navigation device 30 executes route guidance to the user. More specifically, the controller 35 searches for a route to the destination based on information regarding a current position of the vehicle 20 acquired by the positioning unit 36 and the input of the destination, and calculates an expected arrival time at the destination. The controller 35 transmits navigation information, which is calculated based on the route guidance to the user, and includes information regarding the destination and the expected arrival time, to the information processing device 10 through the communication unit 31. In the embodiment, the navigation information includes at least information regarding the destination and the expected arrival time. The navigation information may further include information regarding the route to the destination.

Although the controller 35 transmits various kinds of information to the information processing device 10 through the communication unit 31, in the following description, the description “through the communication unit 31” may be omitted. That is, in the following description, the description that the controller 35 transmits any kind of information to the information processing device 10 means that the controller 35 transmits any kind of information to the information processing device 10 through the communication unit 31.

Although the controller 35 acquires various kinds of information from the information processing device 10 through the communication unit 31, in the following description, the description “through the communication unit 31” may be omitted. That is, in the following description, the description that the controller 35 acquires any kind of information from the information processing device 10 means that the controller 35 acquires any kind of information received from the information processing device 10 by the communication unit 31.

The storage unit 32 of the navigation device 30 stores a device ID of the navigation device 30. The device ID of the navigation device 30 is, for example, an identification number unique to the navigation device 30.

The controller 35 of the navigation device 30 transmits the device ID of the navigation device 30 to the information processing device 10 in association with the navigation information in transmitting the navigation information to the information processing device 10.

The server device 40 functions as a server that provides a calendar application in a cloud computing system.

The storage unit 42 of the server device 40 stores schedule information of the user in association with a user ID of the calendar application. The user ID of the calendar application is, for example, an identification number unique to the user of the calendar application.

In a case where an acquisition request for schedule information is acquired from the information processing device 10 through the communication unit 41, the controller 45 of the server device 40 extracts the schedule information, which is included in the acquisition request and corresponds to the user ID of the calendar application, from the storage unit 42. The controller 45 transmits the extracted schedule information to the information processing device 10 through the communication unit 41.

Although the controller 45 transmits various kinds of information to the information processing device 10 through the communication unit 41, in the following description, the description “through the communication unit 41” may be omitted. That is, in the following description, the description that the controller 45 transmits any kind of information to the information processing device 10 means that the controller 45 transmits any kind of information to the information processing device 10 through the communication unit 41.

Although the controller 45 acquires various kinds of information from the information processing device 10 through the communication unit 41, in the following description, the description “through the communication unit 41” may be omitted. That is, in the following description, the description that the controller 45 acquires any kind of information from the information processing device 10 means that the controller 45 acquires any kind of information received from the information processing device 10 by the communication unit 41.

The storage unit 12 of the information processing device 10 stores the device ID of the navigation device 30 in association with the user ID of the calendar application provided by the server device 40. This means that the storage unit 12 stores the user of the navigation device 30 in association with the user of the calendar application provided by the server device 40.

The controller 15 of the information processing device 10 acquires the navigation information including information regarding the destination and the expected arrival time from the navigation device 30 through the communication unit 11. The controller 15 acquires the device ID of the navigation device 30 from the navigation device 30 through the communication unit 11.

In a case where the device ID of the navigation device 30 is acquired through the communication unit 11, the controller 15 extracts the user ID of the calendar application stored in the storage unit 12 in association with the device ID from the storage unit 12. The controller 15 transmits the acquisition request for schedule information including the extracted user ID of the calendar application to the server device 40 through the communication unit 11.

Although the controller 15 transmits various kinds of information to the navigation device 30 or the server device 40 through the communication unit 11, in the following description, the description “through the communication unit 11” may be omitted. That is, in the following description, the description that the controller 15 transmits any kind of information to the navigation device 30 or the server device 40 means that the controller 15 transmits any kind of information to the navigation device 30 or the server device 40 through the communication unit 11.

Although the controller 15 acquires various kinds of information from the navigation device 30 or the server device 40 through the communication unit 11, in the following description, the description “through the communication unit 11” may be omitted. That is, in the following description, the description that the controller 15 acquires any kind of information from the navigation device 30 or the server device 40 means that the controller 15 acquires any kind of information received from the navigation device 30 or the server device 40 by the communication unit 11.

The controller 15 transmits the acquisition request for schedule information including the user ID of the calendar application to the server device 40, and acquires the schedule information of the user identified by the user ID transmitted from the server device 40 according to the acquisition request and. Since the user ID of the calendar application is the user ID that is used by the user of the navigation device 30 for the calendar application, the schedule information acquired from the server device 40 by the controller 15 is the schedule information of the user of the navigation device 30.

In a case where the schedule information of the user of the navigation device 30 is acquired from the server device 40, the controller 15 extracts an action start time of the user at the destination from the schedule information to acquire the action start time. For example, when the destination input to the navigation device 30 is a hotel, and information regarding check-in at the hotel at 15 is included in the schedule information, the controller 15 extracts information “at 15” as the action start time.

The controller 15 calculates a spare time between the expected arrival time at the destination acquired from the navigation device 30 and the action start time at the destination extracted from the schedule information of the user. In the embodiment, the controller 15 calculates the spare time by subtracting the expected arrival time from the action start time. For example, when the action start time is 15 o'clock, and the expected arrival time is 13 o'clock, the controller 15 subtracts 13 o'clock from 15 o'clock. As a result, the spare time is calculated as two hours.

The storage unit 12 of the information processing device 10 stores a plurality of stopover candidates. A stopover candidate is a facility or an event that is presented as a candidate of a stopover target to the user of the navigation device 30 when the vehicle 20 mounted with the navigation device 30 arrives at the destination affordably. When the stopover candidate is a facility, the stopover candidate may be, for example, a restaurant, a cafe, a shopping mall, a park, a museum, an art gallery, a sightseeing facility, or the like. When the stopover candidate is an event, the stopover candidate may be, for example, a free market, a festival, a fireworks display, or the like. The storage unit 12 stores, for each stopover candidate, positional information of the stopover candidate in association with a stay time assumed that a person normally stays at the stopover candidate, or the like.

The information processing device 10 can store information regarding a new stopover candidate in the storage unit 12 or can update information regarding a stopover candidate stored in the storage unit 12 by receiving an input of information regarding a stopover candidate to the input unit 13 or acquiring information regarding a stopover candidate from a device connected to the network 50.

Information regarding to the stay time of the stopover candidate may be based on information collected from a plurality of vehicles parked at a parking lot of the stopover candidate. For example, in a case where an engine or a motor of a vehicle parked at the parking lot of the stopover candidate is turned off, the information processing device 10 acquires information regarding a time, at which the engine or the motor is turned off, from the vehicle through the network 50. In a case where the engine or the motor of the vehicle parked at the parking lot of the stopover candidate is turned on, the information processing device 10 acquires information regarding a time, at which the engine or the motor is turned on, from the vehicle through the network 50. The information processing device 10 calculates a stay time of a specific vehicle at the stopover candidate by subtracting the time, at which the engine or the motor is turned off, from the time, at which the engine or the motor is turned on. The information processing device 10 may calculate the stay time at the stopover candidate based on the time, at which the engine or the motor is turned on or off, on many vehicles, from which information regarding the on or off of the engine or the motor can be acquired, and may update the stay time of the stopover candidate stored in the storage unit 12 based on the stay times of many vehicles. The information processing device 10 may calculate, for example, an average value of the stay times of many vehicles at the stopover candidate and may update the stay time at the stopover candidate using the average value.

The controller 15 of the information processing device 10 extracts a stopover candidate, at which the vehicle 20 going toward the destination can stop over for the spare time, based on the calculated spare time, among the stopover candidates stored in the storage unit 12. The controller 15 decides a stopover candidate to be extracted from the storage unit 12 based on the spare time and a time needed for stopping over at the stopover candidate. The controller 15 extracts a stopover candidate, at which the time needed for stopping over is shorter than the spare time, from the storage unit 12.

The controller 15 calculates the time needed for stopping over at the stopover candidate based on an increase amount of a movement time resulting from stopover at the stopover candidate and a stay time at the stopover candidate. In the embodiment, the controller 15 calculates the time needed for stopping over at the stopover candidate by adding the increase amount of the movement time resulting from stopover at the stopover candidate and the stay time at the stopover candidate.

The controller 15 may extract a stopover candidate solely when the spare time is equal to or greater than a predetermined threshold value. The predetermined threshold value may be, for example, 30 minutes or the like. With this, when the spare time is short and the user does not afford to stop over during movement to the destination, the controller 15 may omit processing of extracting a stopover candidate from the storage unit 12.

The controller 15 transmits information regarding the stopover candidate extracted from the storage unit 12 to the navigation device 30.

When two or more stopover candidates are extracted, the controller 15 may give priority to the stopover candidates based on a predetermined criterion. The controller 15 may transmit information regarding the stopover candidates to the navigation device 30 along with information regarding priority in transmitting information regarding the stopover candidates to the navigation device 30.

The predetermined criterion when the controller 15 gives priority to the stopover candidates may be, for example, a criterion determined based on the spare time. The controller 15 may give higher priority to a stopover candidate, for example, as the time needed for stopping over at the stopover candidate is closer to the spare time. Alternatively, the predetermined criterion may be a criterion determined, for example, based on an evaluation point of a rating site. The controller 15 may give higher priority to a stopover candidate, for example, as the evaluation point of the rating site is higher. Alternatively, the predetermined criterion may be a criterion determined, for example, based on a time period. The controller 15 may give higher priority to a stopover candidate suitable for a time period, during which the vehicle 20 is traveling, for example, may give higher priority to a restaurant in a time period of lunchtime.

The predetermined criterion when the controller 15 gives priority to the stopover candidates may depend on, for example, a vehicle type of the vehicle 20 mounted with the navigation device 30. For example, when the vehicle type of the vehicle 20 mounted with the navigation device 30 is a vehicle type intended for family, such as a min-van, the controller 15 may give higher priority to a facility for family. Information regarding the vehicle type of the vehicle 20 mounted with the navigation device 30 may be transmitted to the information processing device 10 by the navigation device 30.

In a case where information regarding the stopover candidate is acquired from the information processing device 10, the controller 35 of the navigation device 30 may make the output unit 34 display the acquired information regarding the stopover candidate. When information regarding priority is also acquired from the information processing device 10 along with information regarding the stopover candidates, the controller 35 may make the output unit 34 display the stopover candidate with higher priority or make the output unit 34 display the stopover candidates in parallel in a descending order of priority.

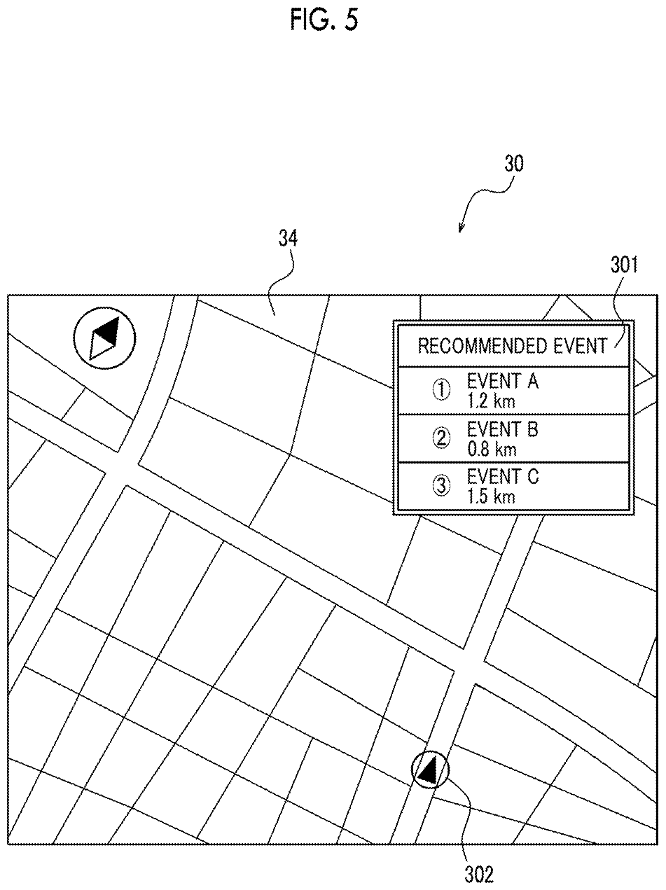

FIG. 5 shows a manner in which the controller 35 of the navigation device 30 makes the output unit 34 display stopover candidates 301 as pop-up display. In the example shown in FIG. 5, three recommended events are displayed as the stopover candidates.

The controller 35 may make the output unit 34 display distances from a current place 302 to the stopover candidates in parallel as shown in FIG. 5 in making the output unit 34 display the stopover candidates. The controller 35 may calculate the distances from the current place to the stopover candidates.

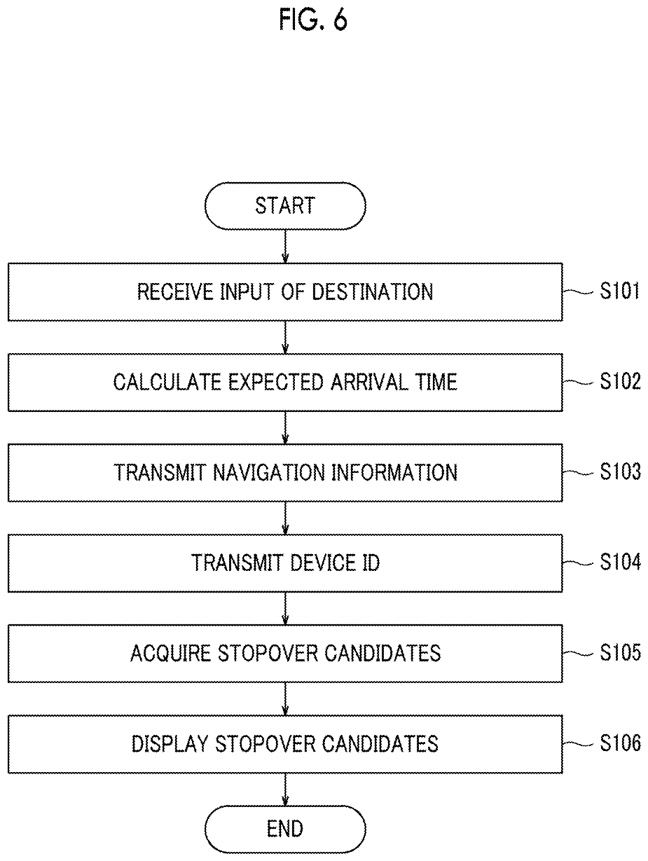

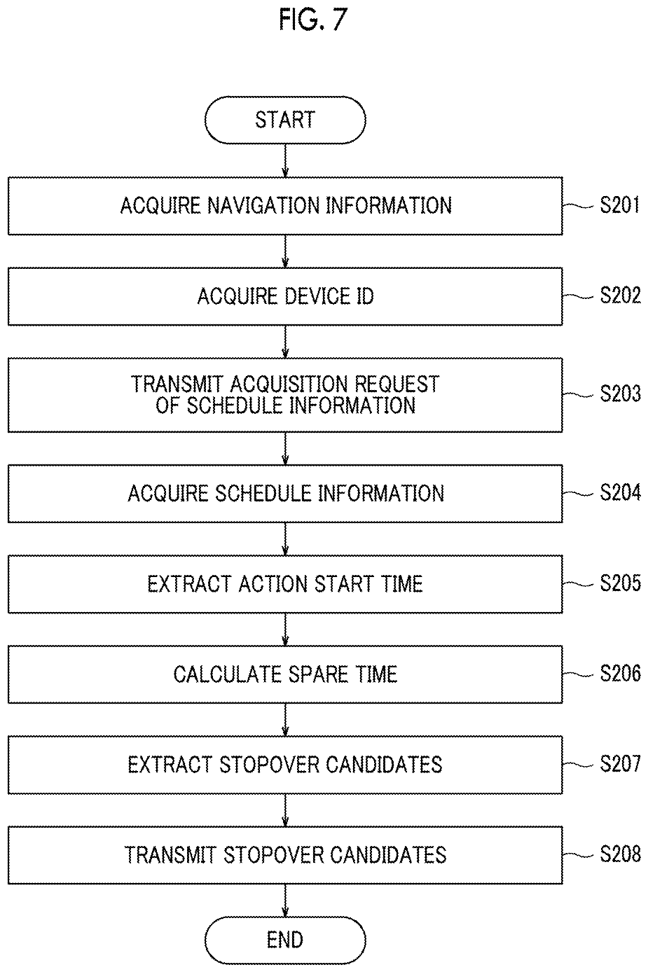

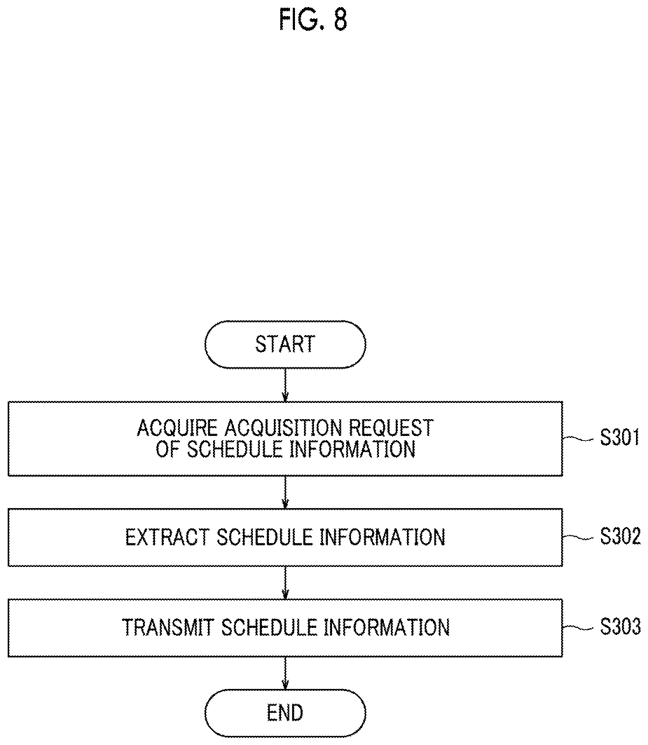

Referring to flowcharts shown in FIGS. 6 to 8, the operation of the information processing system 1 will be described. FIG. 6 is a flowchart primarily showing the operation of the navigation device 30. FIG. 7 is a flowchart primarily showing the operation of the information processing device 10. FIG. 8 is a flowchart primarily showing the operation of the server device 40.

In Step S101 of FIG. 6, the input unit 33 of the navigation device 30 receives an input of a destination from the user of the navigation device 30.

In Step S102 of FIG. 6, the controller 35 of the navigation device 30 searches for a route to the destination based on information regarding a current position of the vehicle 20 acquired by the positioning unit 36 and the input of the destination from the user, and calculates an expected arrival time at the destination.

In Step S103 of FIG. 6, the controller 35 of the navigation device 30 transmits navigation information including the destination and the expected arrival time to the information processing device 10.

In Step S104 of FIG. 6, the controller 35 of the navigation device 30 transmits a device ID of the navigation device 30 to the information processing device 10.

The controller 35 may execute Step S104 before Step S103 or may execute Steps S103 and S104 simultaneously.

In Step S201 of FIG. 7, the controller 15 of the information processing device 10 acquires the navigation information transmitted from the navigation device 30 in Step S103.

In Step S202 of FIG. 7, the controller 15 of the information processing device 10 acquires the device ID of the navigation device 30 transmitted from the navigation device 30 in Step S104.

The controller 15 may execute Step S202 before Step S201 or may execute Steps S201 and S202 simultaneously according to the order of Steps S103 and S104 of FIG. 6.

In Step S203 of FIG. 7, the controller 15 of the information processing device 10 extracts a user ID of a calendar application stored in the storage unit 12 in association with the device ID acquired in Step S202 from the storage unit 12 and transmits an acquisition request for schedule information including the user ID to the server device 40.

In Step S301 of FIG. 8, the controller 45 of the server device 40 acquires the acquisition request for schedule information transmitted from the information processing device 10 in Step S203.

In Step S302 of FIG. 8, the controller 45 of the server device 40 extracts schedule information corresponding to the user ID included in the acquisition request for schedule information from the storage unit 42.

In Step S303 of FIG. 8, the controller 45 of the server device 40 transmits the extracted schedule information to the information processing device 10.

In Step S204 of FIG. 7, the controller 15 of the information processing device 10 acquires the schedule information transmitted from the server device 40 in Step S303.

In Step S205 of FIG. 7, the controller 15 of the information processing device 10 extracts an action start time of the user at the destination from the schedule information.

In Step S206 of FIG. 7, the controller 15 of the information processing device 10 calculates a spare time by subtracting the expected arrival time from the action start time.

In Step S207 of FIG. 7, the controller 15 of the information processing device 10 extracts a stopover candidate to stop over for the spare time from the storage unit 12.

In Step S208 of FIG. 7, the controller 15 of the information processing device 10 transmits information regarding the extracted stopover candidate to the navigation device 30.

In Step S105 of FIG. 6, the controller 35 of the navigation device 30 acquires information regarding the stopover candidate transmitted from the information processing device 10 in Step S208.

In Step S106 of FIG. 6, the controller 35 of the navigation device 30 makes the output unit 34 display the acquired information regarding the stopover candidate.

As described above, in the information processing device 10 according to the embodiment, the controller 15 calculates the spare time between the expected arrival time and the action start time. The controller 15 extracts a stopover candidate to stop over among a plurality of stopover candidates based on the spare time. The controller 15 transmits information regarding the extracted stopover candidate to the navigation device 30. In this way, the information processing device 10 according to the embodiment can provide a stopover candidate to stop over for the spare time until the action start time at the destination based on the expected arrival time. Accordingly, the information processing device 10 according to the embodiment can provide beneficial information based on the expected arrival time.

The present disclosure is not limited to the above-described embodiment. For example, a plurality of blocks shown in the block diagram may be integrated or one block may be divided. Instead of executing a plurality of steps shown in the flowcharts in time series in compliance with the description, the steps may be executed in parallel or in a different order according to the processing ability of a device that executes each step or as needed. Besides, alterations can be made without departing from the spirit and scope of the present disclosure.

For example, a part of processing operations executed in the information processing device 10 in the above-described embodiment may be executed in at least one of the navigation device 30 and the server device 40. At least a part of processing operations executed in at least one of the navigation device 30 and the server device 40 may be executed in the information processing device 10.

For example, a configuration may be made in which general-purpose electronic equipment, such as a computer, is made to function as the information processing device 10 according to the embodiment. Specifically, a program in which the processing contents for implementing the functions of the information processing device 10 and the like according to the embodiment are described can be stored in a memory of the electronic equipment, and the program can be read and executed by a processor of the electronic equipment. Accordingly, the disclosure according to one embodiment can also be implemented as a program that is executable by the processor.

For example, in the above-described embodiment, although the information processing device 10 acquires the schedule information from the server device 40, the information processing device 10 may acquire the schedule information from a device other than the server device 40. The information processing device 10 may acquire the schedule information from, for example, a communication terminal of the user of the navigation device 30. Alternatively, the information processing device 10 may store the schedule information.

For example, in the above-described embodiment, although information regarding the stopover candidate is stored in the storage unit 12 of the information processing device 10, the stopover candidate may be stored in a device other than the storage unit 12. Information regarding the stopover candidate may be stored in, for example, a database provided at a place different from the information processing device 10.

For example, in the above-described embodiment, although a case where the information processing device 10 transmits information regarding the stopover candidate to the navigation device 30 has been described as an example, the information processing device 10 may transmit information regarding the stopover candidate to any device used by the user. The device used by the user may be, for example, a smartphone, a tablet, or the like.

What is claimed is:

1. An information processing device comprising a controller configured to
acquire an expected arrival time at a destination based on route guidance to a user,
acquire an action start time of the user at the destination,
calculate a spare time between the expected arrival time and the action start time,
extract a stopover candidate to stop over from among a plurality of stopover candidates based on the spare time, and
transmit information regarding the extracted stopover candidate to a device used by the user.

2. The information processing device according to claim 1, wherein the controller is configured to acquire schedule information of the user from a server device, extract the action start time from the schedule information, and acquire the action start time.

3. The information processing device according to claim 2, further comprising a storage unit that stores a user ID associated with a device ID of the device used by the user,
wherein the controller is configured to acquire the schedule information of a user identified by the user ID associated with the device ID from the server device.

4. The information processing device according to claim 1, wherein the controller is configured to decide the stopover candidate, which is extracted from among the stopover candidates, based on the spare time and a time needed for a stopover at the stopover candidate.

5. The information processing device according to claim 4, wherein the controller is configured to calculate the time needed for the stopover at the stopover candidate based on an increase amount of a movement time resulting from the stopover at the stopover candidate and a stay time at the stopover candidate.

6. The information processing device according to claim 1, wherein the controller is configured to extract the stopover candidate from among the stopover candidates when the spare time is equal to or greater than a predetermined threshold value.

7. The information processing device according to claim 1, wherein the controller is configured to extract two or more stopover candidates from among the stopover candidates, give priority to the two or more stopover candidates, and transmit information regarding the two or more stopover candidates to a device used by the user along with information regarding the priority.

8. An information processing system comprising:
the information processing device according to claim 1;
a device configured to transmit an expected arrival time to the information processing device; and
a server device configured to transmit schedule information of a user of the device to the information processing device.

9. A program that causes a computer to execute
acquiring an expected arrival time at a destination based on route guidance to a user,
acquiring an action start time of the user at the destination.
calculating a spare time between the expected arrival time and the action start time.
extracting a stopover candidate to stop over from among a plurality of stopover candidates based on the spare time, and
transmitting information regarding the extracted stopover candidate to a device used by the user.

10. The program according to claim 9, causing the computer to further execute
acquiring schedule information of the user from a server device, and
extracting the action start time from the schedule information to acquire the action start time.

11. The program according to claim 10, wherein the acquiring of the schedule information includes acquiring schedule information of a user identified by a user ID associated with a device ID of the device used by the user from the server device.

12. The program according to claim 9, wherein the extracting of the stopover candidate includes deciding the stopover candidate, which is extracted from among the stopover candidates, based on the spare time and a time needed for a stopover at the stopover candidate.

13. The program according to claim 12, wherein the extracting of the stopover candidate includes calculating the time needed for the stopover at the stopover candidate based on an increase amount of a movement time resulting from the stopover at the stopover candidate and a stay time at the stopover candidate.

14. The program according to claim 9, wherein the extracting of the stopover candidate includes extracting the stopover candidate from among the stopover candidates when the spare time is equal to or greater than a predetermined threshold value.

15. An information processing method comprising:
acquiring an expected arrival time at a destination based on route guidance to a user;
acquiring an action start time of the user at the destination;
calculating a spare time between the expected arrival time and the action start time;
extracting a stopover candidate to stop over from among a plurality of stopover candidates based on the spare time; and
transmitting information regarding the extracted stopover candidate to a device used by the user.

16. The information processing method according to claim 15, further comprising:
acquiring schedule information of the user from a server device; and
extracting the action start time from the schedule information to acquire the action start time.

17. The information processing method according to claim 16, wherein the acquiring of the schedule information includes acquiring schedule information of a user identified by a user ID associated with a device ID of the device used by the user from the server device.

18. The information processing method according to claim 15, wherein the extracting of the stopover candidate includes deciding the stopover candidate, which is extracted from among the stopover candidates, based on the spare time and a time needed for a stopover at the stopover candidate.

19. The information processing method according to claim 18, wherein the extracting of the stopover candidate includes calculating the time needed for the stopover at the stopover candidate based on an increase amount of a movement time resulting from the stopover at the stopover candidate and a stay time at the stopover candidate.

20. The information processing method according to claim 15, wherein the extracting of the stopover candidate includes extracting the stopover candidate from among the stopover candidates when the spare time is equal to or greater than a predetermined threshold value.
